(19) United States
(12) Patent Application Publication
(10) Pub. No.: US 2024/0222614 A1
(43) Pub. Date: Jul. 4, 2024

(54) LITHIUM SECONDARY BATTERY

(71) Applicant: TeraWatt Technology K.K., Yokohama-shi (JP)

(72) Inventors: Juichi Arai, Yokohama-shi (JP); Ken Ogata, Yokohama-shi (JP)

(73) Assignee: TeraWatt Technology K.K., Yokohama-shi (JP)

(21) Appl. No.: 18/596,152

(22) Filed: Mar. 5, 2024

Related U.S. Application Data
(63) Continuation of application No. PCT/JP2021/032600, filed on Sep. 6, 2021.

(51) Int. Cl. H01M 4/46; H01M 4/02; H01M 4/134; H01M 10/052

(52) U.S. Cl. CPC H01M 4/466; H01M 4/134; H01M 10/052; H01M 2004/027

(57) ABSTRACT

The present invention provides a lithium secondary battery having a high energy density. The present invention relates to a lithium secondary battery that a lithium metal deposits on a surface of a negative electrode and charge/discharge are performed by electrolytically dissolving the deposited lithium, in which the negative electrode essentially consists of an Mg alloy or an Mg metal.

### CROSS-REFERENCE TO RELATED APPLICATION

This application is a continuation of International Patent Application No. PCT/JP2021/032600, entitled “Lithium Secondary Battery”, filed Sep. 6, 2021, the entire contents of which are incorporated by reference.

### BACKGROUND

### Field

The present invention relates to a lithium secondary battery.

### Description of Related Art

The technology of converting natural energy such as solar light and wind power into electric energy has recently attracted attentions. Under such a situation, various secondary batteries have been developed as a highly-safe power storage device capable of storing a lot of electric energy.

Among them, lithium secondary batteries which perform charge/discharge by transferring lithium ions between a positive electrode and a negative electrode are known to exhibit a high voltage and a high energy density. As typical lithium secondary batteries, lithium-ion secondary batteries (LIB) which have a positive electrode and a negative electrode having an active material capable of retaining lithium element and perform charge/discharge by delivering or receiving lithium ions between a positive-electrode active material and a negative-electrode active material are known.

For the purpose of realizing high energy density, a lithium secondary battery (lithium metal battery; LMB) that lithium metal is used as the negative-electrode active material, instead of a material into which the lithium ion can be inserted, such as a carbon material, has been developed. For example, PCT Japanese Translation Patent Publication No. 2006-500755 discloses a rechargeable battery using, as a negative electrode, an electrode based on lithium metal.

For the purpose of further improving high energy density and improving productivity, or the like, a lithium secondary battery using a negative electrode that does not have a negative-electrode active material such as the carbon material and the lithium metal has been developed.

For example, PCT Japanese Translation Patent Publication No. 2019-505971 discloses a lithium secondary battery including a positive electrode and a negative electrode, and a separation membrane and an electrolyte interposed therebetween. In the aforesaid negative electrode, metal particles are formed on a negative electrode current collector and transferred from the positive electrode, when the battery is charged, to form lithium metal on the negative electrode current collector in the negative electrode. PCT Japanese Translation Patent Publication No. 2019-505971 discloses that such a lithium secondary battery shows the possibility of providing a lithium secondary battery which has overcome the problem due to the reactivity of the lithium metal and the problem caused during assembly process and therefore has improved performance and service life.

### SUMMARY

In the lithium secondary battery described in Patent Documents 1 and 2 above, in which a lithium metal deposits on a surface of the negative electrode and charge/discharge are performed by electrolytically dissolving the resulting deposited lithium, although the energy density is high in principle, it is desired to provide a lithium secondary battery having even higher energy density.

The present invention has been made in consideration of the aforesaid problems and a purpose is to provide a lithium secondary battery having a high energy density.

A lithium secondary battery according to one embodiment of the present invention is that a lithium metal deposits on a surface of a negative electrode and charge/discharge are performed by electrolytically dissolving the deposited lithium metal, in which the negative electrode essentially consists of an Mg alloy or an Mg metal.

In the lithium secondary battery that the lithium metal deposits on the surface of the negative electrode and charge/discharge are performed by electrolytically dissolving the deposited lithium metal, the volume and mass of the entire battery are smaller and the energy density is higher in principle as compared with a lithium-ion secondary battery that has a negative-electrode active material for retaining lithium ions in the negative electrode. In addition, since the negative electrode essentially consists of an Mg metal or an alloy thereof, having a small specific gravity, the mass of the battery is small and the energy density is high. It is preferable that a plurality of recessed portions are formed on the surface of the negative electrode on which the lithium metal deposits. In such a mode, the mass of the negative electrode itself is further reduced and a surface area of a reaction field of the negative electrode is increased in the recessed portions, so that the energy density and/or cycle characteristic of the lithium secondary battery is further improved.

It is preferable that the recessed portion is filled with a gel electrolyte. In such a mode, the energy density of the lithium secondary battery is further improved.

It is preferable that a plurality of through-holes penetrating between the surface of the negative electrode on which the lithium metal deposits and a surface on a side opposite to the surface are formed in the negative electrode. In such a mode, the mass of the negative electrode itself is further reduced and a surface area of a reaction field of the negative electrode is increased in the through-holes, so that the energy density and/or cycle characteristic of the lithium secondary battery is further improved.

It is preferable that the through-hole is filled with a gel electrolyte. In such a mode, the energy density of the lithium secondary battery is further improved.

An average thickness of the negative electrode is preferably 3.0 μm or more and 30 μm or less. In such a mode, the energy density of the lithium secondary battery is further improved.

It is preferable that a specific gravity of the negative electrode is 1.0 g/cm³ or more and 3.5 g/cm³ or less. In such a mode, the energy density of the lithium secondary battery is further improved.

It is preferable that the Mg alloy contains 50 mol % or more of an Mg atom with respect to the total number of moles of atoms in the Mg alloy. In such a mode, the energy density of the lithium secondary battery is further improved.

It is preferable that the Mg alloy is an alloy consisting of Mg and at least one selected from the group consisting of Al, Li, Zn, Mn, Fe, Si, Cu, Ni, and Ca. In such a mode, the cycle characteristic and/or energy density of the lithium secondary battery is further improved.

In the lithium secondary battery, it is preferable that, before an initial charge, a lithium foil is not formed on the surface of the negative electrode. In such a mode, the safety and/or energy density of the lithium secondary battery is further improved.

It is preferable that an energy density of the lithium secondary battery is 425 Wh/kg or more.

The present invention makes it possible to provide a lithium secondary battery having a high energy density.

### BRIEF DESCRIPTION OF DRAWINGS

FIG. 1 is a schematic cross-sectional view of the lithium secondary battery according to the present embodiment.

FIG. 2 is a schematic cross-sectional view of the lithium secondary battery according to the present embodiment during use.

FIG. 3 is a schematic cross-sectional view of another aspect of the negative electrode according to the present embodiment.

FIG. 4 is a schematic cross-sectional view of another aspect of the negative electrode according to the present embodiment.

### DETAILED DESCRIPTION

The embodiment of the present invention (which will hereinafter be called “present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship shown in the drawings. Further, a dimensional ratio in the drawings is not limited to the ratio shown in the drawings.

### Present Embodiment

### (Lithium Secondary Battery)

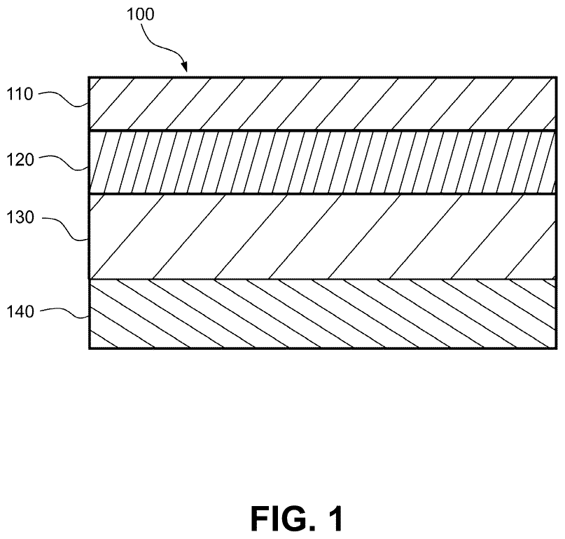

FIG. 1 is a schematic cross-sectional view of the lithium secondary battery according to the present embodiment. As shown in FIG. 1, a lithium secondary battery 100 according to the present embodiment includes a positive electrode 120, a negative electrode 140, a separator 130 placed between the positive electrode 120 and the negative electrode 140, and an ionic conductive material which is not shown in FIG. 1. The positive electrode 120 has a positive electrode current collector 110 on the surface thereof opposite to the surface facing the separator 130. In FIG. 1, the negative electrode 140 is represented as a flat plate, but the negative electrode 140 is not limited to the flat plate and may be various aspects including aspects described later.

In the lithium secondary battery according to the present embodiment, the lithium metal deposits on the surface of the negative electrode, and charge/discharge are performed by electrolytically dissolving the deposited lithium. That is, the lithium secondary battery according to the present embodiment is charged and discharged by a method different from that of a lithium ion battery (LIB).

The detailed differences will be described later in the description of each configuration.

Hereinafter, each configuration of the lithium secondary battery 100 will be described.

### (Negative Electrode)

The negative electrode essentially consists of an Mg alloy or an Mg metal. Since the mass of such a negative electrode is smaller than that of an electrode (for example, a Cu, Ni, or SUS electrode) used as a negative electrode of the lithium secondary battery in the related art, the lithium secondary battery according to the present embodiment has a high energy density.

In the lithium secondary battery, typically, a method of reducing the thickness of the negative electrode is used in order to increase the energy density. On the other hand, in a case where the thickness of the negative electrode is reduced, a mechanical strength is reduced, and thus the negative electrode may be cut, bent, and/or damaged. In addition, in a case where the thin negative electrode is used to manufacture the lithium secondary battery, it is difficult to handle the thin negative electrode, and thus the time and cost required for manufacturing the lithium secondary battery tend to increase. Therefore, a method of increasing the energy density without reducing the thickness of the negative electrode is preferable. As a result of studying various negative electrode materials having a small specific gravity, the present inventors have found that the Mg alloy or the Mg metal is appropriate for sufficiently increasing the energy density of the lithium secondary battery without reducing the thickness of the negative electrode.

Mg has a specific gravity of approximately 1.74 g/cm³, and has a small specific gravity among metals as shown in Table 1. Therefore, an alloy containing the Mg atom also tends to have a smaller specific gravity than other alloys. In addition, Mg has a high electrical conductivity and can be suitably used as an electrode.

Furthermore, it is found that the Mg alloy or the Mg metal exhibits excellent resistance to deterioration due to a reaction with lithium ions during charge/discharge of the lithium secondary battery, as compared with other light metals or alloys of other light metals. Examples of the metal element having a small specific gravity include Al and Ca. However, it is found that the metal such as Al and Ca tends to cause a decrease in corrosion resistance and/or toughness due to the reaction with lithium ions during the charge/discharge, and is not suitable as a negative electrode material for a lithium secondary battery which is subjected to repeated charge/discharge. That is, the negative electrode essentially consisting of the Mg alloy or the Mg metal has favorable properties as a negative electrode material, such as electrical conductivity and durability, as compared with other metal materials having a small specific gravity.

Therefore, in a case where the negative electrode essentially consisting of the Mg alloy or the Mg metal is used, it is possible to further increase the energy density of the lithium secondary battery without reducing the thickness of the negative electrode.

TABLE 1

| Metal element | Li | Na | Ca | Mg | Al | Ti | Zr | Zn | Cr | Mn | Fe |
|---|---|---|---|---|---|---|---|---|---|---|---|
| Specific gravity | 0.53 | 0.97 | 1.55 | 1.74 | 2.70 | 4.54 | 6.50 | 7.13 | 7.20 | 7.44 | 7.87 |
| (g/cm³) | | | | | | | | | | | |

| Metal element | Co | Ni | Cu | Mo | Ag | Pb | Pd | W | Au | Pt |
|---|---|---|---|---|---|---|---|---|---|---|
| Specific gravity | 8.90 | 8.90 | 8.96 | 10.22 | 10.50 | 11.35 | 12.02 | 19.30 | 19.32 | 21.45 |
| (g/cm³) | | | | | | | | | | |

In the lithium secondary battery according to the present embodiment, the lithium metal deposits on the surface of the negative electrode by charge of the battery, and the deposited lithium is electrolytically dissolved by discharge of the battery, whereby the charge/discharge are performed. Therefore, the negative electrode 140 functions as a negative electrode current collector.

It is preferable that the lithium secondary battery 100 is a battery in which, before an initial charge, a lithium foil is not formed on the surface of the negative electrode 140 (an interface between the negative electrode 140 and the separator 130). In such a mode, it is not necessary to directly handle the highly reactive lithium metal during the manufacturing, and thus it is possible to obtain a lithium secondary battery having more excellent cycle characteristic, safety, and/or productivity.

In this aspect, in a case where the lithium secondary battery 100 is initially charged, it is considered that Mg exposed on the surface of the negative electrode 140 and Li supplied from the electrolyte solution or the like react with each other, a thin Mg—Li alloy is formed on the negative electrode 140, and then a layer containing mainly the lithium metal is deposited on the Mg—Li alloy layer. In addition, in this aspect, the lithium metal deposited on the negative electrode 140 is a lithium metal derived from the positive electrode 120.

The “lithium metal” as used herein refers to lithium in a metal state and includes a lithium metal containing impurities other than lithium. Furthermore, the description of simply “lithium” represents a lithium element, a lithium atom, or a lithium ion.

In addition, the “before initial charge” of the battery as used herein means a state from the time when the battery is assembled to the time when the battery is first charged. In addition, “at the end of discharging” of the battery means a state in which the battery voltage is 1.0 V or more and 3.8 V or less, preferably 1.0 V or more and 3.0 V or less.

In a case where the lithium secondary battery according to the present embodiment is compared with a lithium ion battery (LIB), the following points are different.

In the lithium ion battery (LIB), a negative electrode has a host material for a lithium element (lithium ions or lithium metal), this material is filled with the lithium element when the battery is charged, and the host material releases the lithium element, thereby discharging the battery. That is, in the LIB, the host material of the negative electrode holds the lithium element, while in the lithium secondary battery according to the present embodiment, the lithium metal is directly formed on the surface of the negative electrode as described above, which is a different point.

In the lithium ion battery (LIB), since it is necessary to increase the amount of the negative-electrode active material with respect to the mass of the negative electrode current collector (which may correspond to the negative electrode in the present embodiment), the effect of increasing the energy density is limited even in a case where the specific gravity of the negative electrode current collector is small, and the aforesaid effect in the lithium secondary battery according to the present embodiment cannot be expected.

The negative electrode in the present embodiment may contain a component other than the Mg alloy and the Mg metal in a range that does not impair the effects of the present embodiment. Examples of the component other than the Mg alloy include metal atoms which are not alloyed with the Mg metal, and inevitable impurities such as substances other than metals. Examples of the component other than the Mg metal include metal atoms other than the Mg metal, and inevitable impurities such as substances other than metals.

The negative electrode in the present embodiment may essentially consist of the Mg metal. In this case, the negative electrode may contain inevitable impurities in a range that does not impair the effects of the present embodiment. Such inevitable impurities are not particularly limited, and may be, for example, Fe, Mn, Co, P, and S.

The negative electrode in the present embodiment may consist of the Mg alloy. In this case, the negative electrode consists of the Mg metal and one or more metals which can be alloyed with the Mg metal. The negative electrode in the present embodiment may essentially consist of the Mg alloy. In this case, the negative electrode may contain metal atoms which are not alloyed with the Mg metal, or inevitable impurities such as substances other than metals. Such inevitable impurities are not particularly limited, and may be, for example, Fe, Mn, Co, P, and S.

The Mg alloy used for the negative electrode 140 can be used as the negative electrode of the lithium secondary battery, and is not particularly limited insofar as it contains Mg. From the standpoint of increasing the energy density of the lithium secondary battery 100 while ensuring favorable durability and electronic conductivity of the negative electrode, it is preferable that the Mg alloy used for the negative electrode 140 contains, in addition to Mg, at least one selected from the group consisting of Al, Li, Zn, Mn, Fe, Si, Cu, Ni, and Ca. From the similar standpoint, it is more preferable that the Mg alloy used for the negative electrode 140 contains at least one selected from the group consisting of Al, Li, Zn, Mn, and Fe, still more preferable to contain at least one selected from the group consisting of Li, Zn, and Fe, and even more preferable to contain Li or Zn.

The Mg alloy may consist of the Mg metal and at least one metal selected from the group consisting of AI, Li, Zn, Mn, Fe, Si, Cu, Ni, and Ca. The Mg alloy may essentially consist of the Mg metal and at least one metal selected from the group consisting of Al, Li, Zn, Mn, Fe, Si, Cu, Ni, and Ca. In this aspect, the metal other than the Mg metal may be at least one metal selected from the group consisting of Al, Li, Zn, Mn, and Fe, the group consisting of Li, Zn, and Fe, or the group consisting of Li and Zn.

Examples of the Mg alloy used for the negative electrode 140 include known alloys such as AZ31, AZ31B, AZ61, AZ91, AM60, AM80, and LZ91. Chemical compositions of the Mg alloys are as shown in Table 2, for example.

TABLE 2

| | Content (% by mass) | | | | | | | | |
|---|---|---|---|---|---|---|---|---|---|
| Alloy | Al | Li | Zn | Mn | Fe | Si | Cu | Ni | Ca |
| AZ31B | 2.5 to 3.5 | — | 0.60 to 1.40 | 0.20 to 1.00 | ≤0.005 | ≤0.10 | ≤0.05 | ≤0.005 | ≤0.040 |
| AZ61 | 5.5 to 6.5 | — | 0.5 to 1.5 | 0.15 to 0.4 | ≤0.005 | ≤0.005 | ≤0.005 | ≤0.005 | ≤0.005 |
| AZ91 | 8.5 to 9.5 | — | 0.45 to 0.9 | 0.17 to 0.40 | ≤0.004 | ≤0.05 | ≤0.025 | ≤0.001 | — |
| AM60 | 5.5 to 6.5 | — | ≤0.22 | 0.13 to 0.60 | — | — | — | — | — |
| LZ91 | — | 8.5 to 9.5 | 0.50 to 1.50 | — | ≤0.005 | — | — | — | — |

As the negative electrode 140 in the present embodiment, the Mg metal, AZ31B, AZ91, AM60, or LZ91 is preferably used, and LZ91 is more preferably used.

The Mg alloy or the Mg metal used for the negative electrode 140 may be produced by a known method, or a commercially available product thereof may be used.

An upper limit value of a specific gravity of the negative electrode 140 essentially consisting of the Mg alloy or the Mg metal is not particularly limited, and is, for example, 4.0 g/cm³ or less. From the standpoint of increasing the energy density of the lithium secondary battery 100, the upper limit value of the specific gravity of the negative electrode 140 is preferably 3.8 g/cm³ or less, more preferably 3.5 g/cm³ or less, still more preferably 3.0 g/cm³ or less, and even more preferably 2.5 g/cm³ or less.

In addition, the lower limit value of the specific gravity of the negative electrode 140 essentially consisting of the Mg alloy or the Mg metal is not particularly limited, and may be, for example, 0.9 g/cm³ or more, 1.0 g/cm³ or more, 1.1 g/cm³ or more, 1.2 g/cm³ or more, or 1.3 g/cm³ or more.

As specific gravities of representative Mg alloys and Mg metals at a condition of 20° C., a specific gravity of AZ31B is 1.78 g/cm³, a specific gravity of AZ91 is 1.83 g/cm³, a specific gravity of AM60 is 1.81 g/cm³, a specific gravity of LZ91 is 1.50 g/cm³, a specific gravity of the Mg metal is 1.74 g/cm³.

A capacity of the negative electrode 140 with regard to the alloying reaction with the lithium metal is not particularly limited, and is, for example, 30% or less with respect to a capacity of the positive-electrode active material in the positive electrode 120. Such a capacity may be 25% or less, 20% or less, 15% or less, or 10% or less. The capacity of the positive-electrode active material in the positive electrode 120 and the capacity of the negative electrode 140 with regard to the alloying reaction with the lithium metal can be measured by a method known in the related art.

In the lithium secondary battery 100 according to the present embodiment, the capacity of the negative electrode 140 with regard to the alloying reaction with the lithium metal is sufficiently smaller than the capacity of the positive-electrode active material in the positive electrode 120. Therefore, it can be said that the lithium secondary battery 100 performs the charge/discharge by the lithium metal being deposited on the surface of the negative electrode and the deposited lithium being electrolytically dissolved.

An average thickness of the negative electrode 140 is not particularly limited, and is, for example, 1.0 μm or more and 60 μm or less. From the standpoint of improving the stability of the negative electrode 140 while increasing the energy density of the lithium secondary battery 100, the average thickness of the negative electrode 140 is preferably 2.0 μm or more and 45 μm or less, more preferably 3.0 μm or more and 30 μm or less, still more preferably 5.0 μm or more and 28 μm or less, even more preferably 8.0 μm or more and 25 μm or less, and particularly preferably 10 μm or more and 20 μm or less.

In the present embodiment, the average thickness can be measured using a known measurement method. For example, it can be measured by cutting the lithium secondary battery in a thickness direction and observing the exposed cut section by a scanning electron microscope (SEM) or a transmission electron microscope (TEM). The “average thickness” and “thickness” in the present embodiment are found by calculating an arithmetic mean of the thicknesses measured 3 times or more and preferably 5 times or more.

In a case where the Mg metal used for the negative electrode 140 contains impurities, a content of the Mg atom in the Mg metal is not particularly limited, and for example, may be more than 99.0% by mass with respect to the total mass of the Mg metal. From the standpoint of increasing the energy density of the lithium secondary battery 100, in the Mg metal used for the negative electrode 140, the Mg atom is preferably contained in an amount of 99.2% by mass or more, more preferably contained in an amount of 99.5% by mass or more, and still more preferably contained in an amount of 99.8% by mass or more with respect to the total mass of the metal.

The Mg alloy used for the negative electrode 140 is not particularly limited insofar as it is an alloy containing Mg, and a content of the Mg atoms in the Mg alloy is also not particularly limited. The content of the Mg atom in the Mg alloy may be, for example, 50 mol % or more with respect to the total number of moles of atoms in the Mg alloy. From the standpoint of increasing the energy density of the lithium secondary battery 100, the Mg alloy used for the negative electrode 140 preferably contains 55 mol % or more, more preferably 60 mol % or more, still more preferably 70 mol % or more, and even still more preferably 80 mol % or more of the Mg atom with respect to the total number of moles of atoms in the Mg alloy. The upper limit of the content of the Mg atom in the Mg alloy is not particularly limited, and may be 99 mol % or less, 97 mol % or less, 95 mol % or less, 92 mol % or less, or 85 mol % or less with respect to the total number of moles of atoms in the Mg alloy.

In terms of mass ratio, the content of the Mg atom in the Mg alloy used for the negative electrode 140 may be, for example, 60% by mass or more and 99% by mass or less with respect to the total mass of the Mg alloy. From the standpoint of improving the properties of the negative electrode 140 while increasing the energy density of the lithium secondary battery 100, the Mg alloy contains the Mg atom in an amount of preferably 65% by mass or more and 98% by mass or less, more preferably 70% by mass or more and 97% by mass or less, still more preferably 75% by mass or more and 95% by mass or less, and even more preferably 80% by mass or more and 90% by mass or less with respect to the total mass of the metal.

In a case where the Mg alloy contains Al, a content of Al is not particularly limited, and may be, for example, 0.010% by mass or more and 12% by mass or less with respect to the total mass of the Mg alloy. The content of Al in the Mg alloy may be 0.050% by mass or more and 10% by mass or less, 0.10% by mass or more and 8.0% by mass or less, 0.50% by mass or more and 7.0% by mass or less, 1.0% by mass or more and 5.0% by mass or less, or 2.0% by mass or more and 4.0% by mass or less.

In a case where the Mg alloy contains Li, a content of Li is not particularly limited, and may be, for example, 0.010% by mass or more and 15% by mass or less with respect to the total mass of the Mg alloy. The content of Li in the Mg alloy may be 0.10% by mass or more and 14% by mass or less, 1.0% by mass or more and 13% by mass or less, 3.0% by mass or more and 12% by mass or less, 5.0% by mass or more and 11% by mass or less, 7.0% by mass or more and 10% by mass or less, or 8.5% by mass or more and 9.5% by mass or less.

In a case where the Mg alloy contains Zn, a content of Zn is not particularly limited, and may be, for example, 0.0010% by mass or more and 10% by mass or less with respect to the total mass of the Mg alloy. The content of Zn in the Mg alloy may be 0.0050% by mass or more and 8.0% by mass or less, 0.010% by mass or more and 5.0% by mass or less, 0.1% by mass or more and 3.0% by mass or less, or 0.5% by mass or more and 2.0% by mass or less.

In a case where the Mg alloy contains Mn, Fe, Si, Cu, Ni, or Ca, a content of Mn, Fe, Si, Cu, Ni, or Ca is not particularly limited, and may be each independently, for example, 0.0001% by mass or more and 7.0% by mass or less with respect to the total mass of the Mg alloy. The contents of the aforesaid metal elements may be each independently 0.0005% by mass or more and 3.0% by mass or less, 0.001% by mass or more and 1.0% by mass or less, 0.005% by mass or more and 0.5% by mass or less, or 0.01% by mass or more and 0.1% by mass or less. The contents of the respective metal elements are independent and do not prevent from being different values.

A crystal structure of the Mg metal or the Mg alloy used for the negative electrode 140 is not particularly limited, and examples thereof include an hcp structure (hexagonal close-packed crystal), a bcc structure (body-centered cubic crystal), and a mixed phase structure of the hcp structure and the bcc structure. The crystal structure of the negative electrode 140 may be a mixed phase structure of the hcp structure and the bcc structure, or the bcc structure.

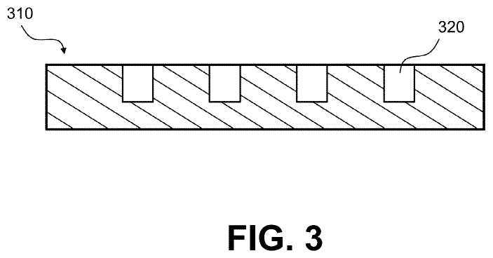

FIG. 3 is an aspect of a negative electrode different from the negative electrode 140. A negative electrode 310 is formed with a plurality of recessed portions 320 in the negative electrode 140. The plurality of recessed portions 320 are formed on the surface on which the lithium metal deposits, that is, a surface facing the separator. The negative electrode 310 may have the same chemical composition, average thickness, capacity, and the like as the negative electrode 140. In the lithium secondary battery 100, the negative electrode 310 may be used instead of the negative electrode 140.

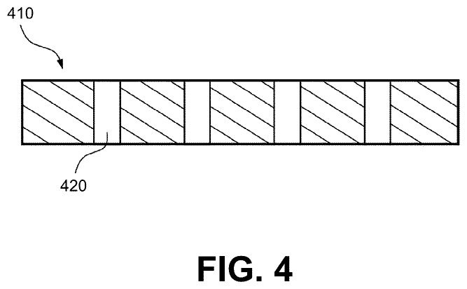

FIG. 4 is an aspect of a negative electrode different from the negative electrode 140. A negative electrode 410 is formed with a plurality of through-holes 420 in the negative electrode 140. The negative electrode 410 may have the same chemical composition, average thickness, capacity, and the like as the negative electrode 140. In the lithium secondary battery 100, the negative electrode 410 may be used instead of the negative electrode 140.

Since the negative electrode 310 or the negative electrode 410 has a plurality of recessed portions 320 or a plurality of through-holes 420, the mass of the negative electrode is reduced and the area where the lithium metal can deposit is increased, and thus the energy density and/or the cycle characteristic of the lithium secondary battery 100 can be improved.

The recessed portion 320 or the through-hole 420 may be filled with an ionic conductive material described later. The ionic conductive material is not particularly limited, and examples thereof include an electrolyte solution, a gel electrolyte, and a polymer electrolyte. From the standpoint of further improving the energy density while maintaining the stability and/or the cycle characteristic of the lithium secondary battery, it is preferable that the recessed portion 320 or the through-hole 420 is filled with the electrolyte solution or the gel electrolyte, and it is more preferable that the recessed portion 320 or the through-hole 420 is filled with the gel electrolyte. The electrolyte solution, the gel electrolyte, and the polymer electrolyte which are filled in the recessed portion 320 or the through-hole 420 are not particularly limited, and substances described later may be used.

A shape of the recessed portion 320 or the through-hole 420 is not particularly limited, and may be, for example, a circle, an ellipse, a rectangle, or a polygon on the surface (the surface facing the separator). From the standpoint of improving the productivity of the lithium secondary battery 100, the shape of the recessed portion 320 or the through-hole 420 may be a circle. A method of forming the plurality of recessed portions 320 or the through-holes 420 is not particularly limited, and a known method may be used. Examples of a method of forming the plurality of recessed portions 320 include etching, molding, and scratching. In addition, examples of a method of forming the plurality of through-holes 420 include laser processing, punching, and etching.

An average pore diameter of the recessed portion 320 or the through-hole 420 is not particularly limited, and is, for example, 0.20 μm or more and 100 μm or less. From the standpoint of improving the energy density and the productivity of the lithium secondary battery 100, the pore diameter of the recessed portion 320 or the through-hole 420 is preferably 0.30 μm or more and 75 μm or less, more preferably 0.50 μm or more and 50 μm or less, and still more preferably 1.0 μm or more and 30 μm or less. The pore diameter of the recessed portion 320 or the through-hole 420 may be 3.0 μm or more, 5.0 μm or more, 10 μm or more, or 15 μm or more. The “average pore diameter” of the recessed portion 320 or the through-hole 420 as used herein means an average value of equivalent circle diameters of the recessed portions 320 or the through-holes 420 on the surface of the negative electrode 310 or the negative electrode 410 facing the separator. The average value is calculated from at least five through-holes. A depth of the recessed portion 320 may be 5% or more, 10% or more, 20% or more, or 30% or more of the thickness of the negative electrode 310. The depth of the recessed portion 320 may be 80% or less, 70% or less, 60% or less, or 50% or less of the thickness of the negative electrode 310.

An opening ratio of the negative electrode 310 or the negative electrode 410 is not particularly limited, and is, for example, 1% or more and 40% or less. From the standpoint of improving the energy density and the productivity of the lithium secondary battery 100, the opening ratio of the negative electrode 310 or the negative electrode 410 may be 2% or more and 30% or less, 3% or more and 25% or less, 4% or more and 20% or less, or 5% or more and 15% or less. The “opening ratio” of the negative electrode 310 or the negative electrode 410 as used herein means a proportion (S2/(S1+S2)) of an area (S2) of the through-hole portion to a sum of an area (S1) of the metal portion and the area (S2) of the through-hole portion on the surface of the negative electrode 310 or the negative electrode 410 facing the separator.

In the negative electrode 140, a part or the entire surface facing the separator 130 may be coated with a coating agent. A compound used as the coating agent is not particularly limited, and it may be a compound including an aromatic ring in which two or more elements selected from the group consisting of N, S, and O are each independently bonded, that is, a compound having a structure in which two or more of N, S, and O are independently bonded to an aromatic ring. Examples of the aromatic ring include aromatic hydrocarbons such as benzene, naphthalene, azulene, anthracene, and pyrene, and heteroaromatic compounds such as furan, thiophene, pyrrole, imidazole, pyrazole, pyridine, pyridazine, pyrimidine, and pyrazine. Among these, an aromatic hydrocarbon is preferable, benzene or naphthalene is more preferable, and benzene is still more preferable. In addition, the aforesaid negative electrode coating agent may be used alone or in combination of two or more thereof. In a case where the negative electrode is coated with the coating agent, the cycle characteristic of the lithium secondary battery can be improved further. Furthermore, a conductive aid or a lithium salt, which will be described later, may be mixed with the aforesaid negative electrode coating agent as necessary.

The negative electrode coating agent is not particularly limited, and examples thereof include benzotriazole (BTA), imidazole (IM), triazinethiol (TAS), polybenzoimidazole, polyimide, polysulfone (PSU), polytetrafluoroethylene (PTFE), polyvinylidene fluoride (PVDF), and derivatives thereof.

In the negative electrode 140, a part or the entire surface facing the separator 130 may be covered with a metal thin film other than Mg. That is, in one aspect of the present embodiment, the negative electrode may have a metal thin film other than Mg, which is formed on the Mg alloy or the Mg metal. The metal thin film may have a very small film thickness as compared with the Mg alloy or the Mg metal.

The covering metal thin film may be, for example, a metal thin film having low reactivity with the Li metal. Examples of the metal include Cu, Au, Ag, and Pt. In a case where the negative electrode 140 is covered with a metal thin film having low reactivity with the Li metal, the lithium secondary battery 100 tends to have more excellent cycle characteristic.

In addition, a thickness of the aforesaid metal thin film is not particularly limited, and may be, for example, 1/10 or less, 1/50 or less, or 1/100 or less with respect to the thickness of the Mg metal or the Mg alloy. Specifically, the thickness of the metal thin film may be 10 nm or more and 60 nm or less, and may be 20 nm or more and 30 nm or less. A method of forming the metal thin film is not particularly limited, and examples thereof include vapor deposition, sputtering, and CVD.

### (Ionic Conductive Material)

The lithium secondary battery 100 has an ionic conductive material which is not shown in FIG. 1. The “ionic conductive material” as used herein refers to a substance having ionic conductivity, which contains at least an electrolyte (that is, a salt), and is a material which acts as a conduction path of lithium ions. Therefore, in the lithium secondary battery 100 having the ionic conductive material, an internal resistance is further reduced, and the energy density, the capacity, and the cycle characteristic are improved further.

The ionic conductive material may be present as a material for filling a housing (pouch) of the battery, may be impregnated in the separator, may be present as an ionic conductive material layer separate from each layer shown in FIG. 1, or may fill a void portion in the negative electrode and/or the positive electrode.

The ionic conductive material is not particularly limited insofar as it is a material commonly used in the lithium secondary battery, and a known material can be selected as needed, depending on the use of the lithium secondary battery. Specific examples thereof include an electrolyte solution, a gel electrolyte, and a polymer electrolyte. The ionic conductive material may be an electrolyte solution or a gel electrolyte, and may be a gel electrolyte.

The electrolyte solution is a material containing at least a solvent and an electrolyte (salt). Both the polymer electrolyte and the gel electrolyte are electrolytes containing a polymer and a salt, and a gel-like electrolyte obtained by containing an electrolyte solution or a solvent is referred to as the gel electrolyte. The polymer electrolyte is not particularly limited, and examples thereof include a solid polymer electrolyte mainly containing a polymer and an electrolyte and a semi-solid polymer electrolyte mainly containing a polymer, an electrolyte, and a plasticizer.

The solvent which can be contained in the electrolyte solution, the polymer electrolyte, and the gel electrolyte as the ionic conductive material is not particularly limited insofar as it is a non-aqueous solvent, and may be a polar solvent or a non-polar solvent.

The solvent component may be selected in consideration of the stability, volatility, solubility of the electrolyte to be used, and the like in the inside of the lithium secondary battery 100. As the solvent component, any of a fluorinated solvent having a fluorine atom or a non-fluorine solvent having no fluorine atom may be used, and both may be used in combination.

The fluorinated solvent is not particularly limited insofar as it acts as the solvent, and examples thereof include an ether compound, an ester compound, a carbonate compound, and a phosphoric acid ester compound, each having at least one fluorine atom. The number of carbon atoms in the fluorinated solvent is not particularly limited, and may be, for example, 2 or more and 50 or less, 2 or more and 40 or less, 3 or more and 20 or less, or 3 or more and 15 or less. In addition, the number of fluorine atoms in the fluorinated solvent is not particularly limited, and may be, for example, 1 or more and 70 or less, 2 or more and 50 or less, 2 or more and 30 or less, 3 or more and 20 or less, or 4 or more and 15 or less.

One of preferred aspects of the fluorinated solvent includes a solvent having a monovalent group represented by Formula (A) or (B). In this aspect, the fluorinated solvent is preferably an ether compound. In this aspect, the fluorinated solvent may have both the monovalent group represented by Formula (A) and the monovalent group represented by Formula (B). According to these aspects, the cycle characteristic of the lithium secondary battery 100 tend to be improved further.

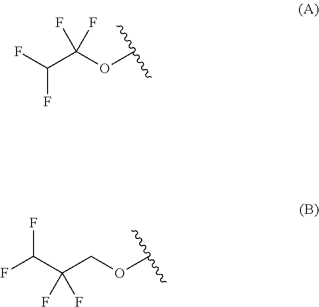

In the formulae, a wavy line represents a bonding site in the monovalent group.

Specific examples of the fluorinated solvent include 1,1,2,2-tetrafluoroethyl-2,2,3,3-tetrafluoropropyl ether (TTFE), 1,1,2,2-tetrafluoroethyl-2,2,2-trifluoroethyl ether (TFEE), ethyl-1,1,2,2-tetrafluoroethyl ether (ETFE), methyl-1,1,2,2-tetrafluoroethyl ether (TFME), 1H,1H,5H-octafluoropentyl-1,1,2,2-tetrafluoroethyl ether (OFTFE), difluoromethyl-2,2,3,3-tetrafluoropropyl ether (DFTFE), methylperfluorobutyl ether (NV7100), ethylperfluorobutyl ether (NV7200), 1,1,1,2,2,3,4,5,5,5-decafluoro-3-methoxy-4-trifluoromethylpentane (NV7300), methyl-2,2,3,3,3-pentafluoropropyl ether, methyl-1,1,2,3,3,3-hexafluoropropyl ether, and ethyl-1,1,2,3,3,3-hexafluoropropyl ether, but the fluorinated solvent is not limited thereto.

The non-fluorine solvent is not particularly limited insofar as it acts as the solvent, and examples thereof include an ether compound, an ester compound, a carbonate compound, and a phosphoric acid ester compound. The number of carbon atoms in the non-fluorine solvent is not particularly limited, and may be, for example, 2 or more and 50 or less, 2 or more and 40 or less, 3 or more and 20 or less, or 3 or more and 15 or less.

Specific examples of the non-fluorine solvent include triethylene glycol dimethyl ether, tetraethylene glycol dimethyl ether, 1,2-dimethoxyethane, dimethoxyethane (DME), dimethoxypropane (DMP), 1,2-dimethoxypropane, 2,2-dimethoxypropane, dimethoxybutane (DMB), 1,3-dimethoxybutane, 1,2-dimethoxybutane, 2,2-dimethoxybutane, 2,3-dimethoxybutane, diethylene glycol dimethyl ether, acetonitrile, dimethyl carbonate, diethyl carbonate, ethyl methyl carbonate, ethylene carbonate, propylene carbonate, chloroethylene carbonate, methyl acetate, ethyl acetate, propyl acetate, methyl propionate, ethyl propionate, trimethyl phosphate, triethyl phosphate, and 12-crown-4, but the non-fluorine solvent is not limited thereto.

The ionic conductive material may contain only any one of the fluorinated solvent or the non-fluorine solvent, or may contain both. In this aspect, the lithium secondary battery 100 may contain, as the fluorinated solvent, the fluorinated solvents described above only one kind or two or more kinds in combination, and may contain, as the non-fluorine solvent, the non-fluorine solvents described above only one kind or two or more kinds in combination.

The aforesaid fluorinated solvent and/or non-fluorine solvent can be freely combined and used in any proportion. A mixing ratio of the fluorinated solvent and the non-fluorine solvent is not particularly limited, and a proportion of the fluorinated solvent to the entire solvent may be 0% by volume or more and 100% by volume or less. In addition, a proportion of the non-fluorine solvent to the entire solvent may be 0% by volume or more and 100% by volume or less.

The salt as the electrolyte, which can be contained in the electrolyte solution, the polymer electrolyte, and the gel electrolyte, is not particularly limited, and examples thereof include salts of Li, Na, K, Ca, and Mg. It is preferable that the lithium secondary battery 100 contains a lithium salt as the electrolyte. The lithium salt is not particularly limited insofar as it acts as the electrolyte, and examples thereof include LiI, LiCl, LiBr, LIF, LiBF₄, LiPF₆, LiAsF₆, LISO₃CF₃, LIN(SO₂F)₂, LIN(SO₂CF₃)₂, LIN(SO₂CF₂CF₃)₂, LiBF₂(C₂O₄), LIB(C₂O₄)₂, LiB(O₂C₂H₄)₂, LiB(OCOCF₃)₄, LiNO₃, and Li₂SO₄. Examples of the salt of Na, K, Ca, or Mg include salts of Nat, K⁺, Ca²⁺, or Mg²⁺ with any anion in the lithium salt described above. One or more of the aforesaid salts may be used alone or in combination. In addition, one or more of the aforesaid lithium salts may be used alone or in combination.

A concentration of the electrolyte in the electrolyte solution is not particularly limited, but is preferably 0.5 M or more, more preferably 0.7 M or more, still more preferably 0.9 M or more, and even more preferably 1.0 M or more. In a case where the concentration of the electrolyte is within the above-described range, the SEI layer is likely to be formed and the internal resistance tends to be further reduced, and thus the cycle characteristic and the rate characteristic of the battery tend to be improved further. The upper limit of the concentration of the electrolyte is not particularly limited, and the concentration of the electrolyte may be equal to or less than a saturated concentration, for example, 10.0 M or less, 5.0 M or less, or 2.0 M or less.

The material constituting the polymer electrolyte or the gel electrolyte is not particularly limited insofar as it is a material generally used for a lithium secondary battery, and a known material can be appropriately selected. The polymer (resin) which can be contained in the polymer electrolyte or the gel electrolyte is not particularly limited, and examples thereof include resins having an ethylene oxide unit in the main chain and/or side chain, such as polyethylene oxide (PEO), acrylic resins, vinyl resins, ester resins, nylon resins, polyvinylidene fluoride (PVDF), polyacrylonitrile (PAN), polysiloxane, polyphosphazene, poly(methyl methacrylate), polyamide, polyimide, aramid, polylactic acid, polyethylene, polystyrene, polyurethane, polypropylene, polybutylene, polyacetal, polysulfone, polytetrafluoroethylene, and a copolymer of vinylidene fluoride and hexafluoropropylene. One or more of the polymers may be used alone or in combination.

In the polymer electrolyte or the gel electrolyte, a content ratio of the polymer and the lithium salt may be determined by a ratio ([Li]/[O]) of the lithium atom in the lithium salt to an oxygen atom in the polymer. In the polymer electrolyte or the gel electrolyte, the content of the polymer and the lithium salt may be adjusted so that the aforesaid ratio ([Li]/[O]) is, for example, 0.02 or more and 0.20 or less, 0.03 or more and 0.15 or less, or 0.04 or more and 0.12 or less.

The plasticizer contained in the semi-solid polymer electrolyte is not particularly limited, and examples thereof include a solvent-similar component that can be contained in the gel electrolyte, and various oligomer.

### (Separator)

The separator 130 is a member for separating the positive electrode 120 from the negative electrode 140 to prevent a short circuit of the battery and in addition, for securing the ionic conductivity of a lithium ion which serves as a charge carrier between the positive electrode 120 and the negative electrode 140. That is, the separator 130 has a function of physically and/or electrically separating the positive electrode 120 and the negative electrode 140, and a function of securing ionic conductivity of lithium ions. Therefore, the separator 130 is formed of a material that does not have electronic conductivity and does not react with lithium ions. In addition, the separator 130 may play a role of holding the electrolyte solution.

As such a separator, one member having the aforesaid two functions may be used singly, or two or more members each having the aforesaid one function may be used in combination. The separator is not particularly limited insofar as it has the aforesaid functions, and examples thereof include a porous member having insulating properties, a polymer electrolyte, a gel electrolyte, and an inorganic solid electrolyte. Typically, it is at least one selected from the group consisting of a porous member having insulating properties, a polymer electrolyte, and a gel electrolyte.

In a case where the separator includes an insulating porous member, the member exhibits ionic conductivity by filling pores of the member with a substance having ionic conductivity. The filling substance may be, for example, the aforesaid ionic conductive material, and it may be at least one of an electrolyte solution, a polymer electrolyte, or a gel electrolyte.

As the separator 130, one or more of the insulating porous member, the polymer electrolyte, or the gel electrolyte may be used alone or in combination. In a case where the insulating porous member is used alone as the separator, the lithium secondary battery needs to further have the ionic conductive material.

A material constituting the aforesaid insulating porous member is not particularly limited, and examples thereof include an insulating polymer material, and specific examples thereof include polyethylene (PE) and polypropylene (PP). That is, the separator 130 may be a porous polyethylene (PE) film, a porous polypropylene (PP) film, or a stacked structure thereof.

The separator 130 may be covered with a separator coating layer. The separator coating layer may cover both of the surfaces of the separator 130 or may cover only one of them. The separator coating layer is not particularly limited insofar as it is a member having ionic conductivity and being not reactive with lithium ions, and is preferably capable of firmly adhering the separator 130 to a layer adjacent to the separator 130. Such a separator coating layer is not particularly limited, and examples thereof include members containing a binder such as polyvinylidene fluoride (PVDF), a composite material (SBR-CMC) of styrene butadiene rubber and carboxymethyl cellulose, polyacrylic acid (PAA), lithium polyacrylate (Li-PAA), polyimide (PI), polyamideimide (PAI), or aramid. The separator coating layer may contain inorganic particles such as silica, alumina, titania, zirconia, magnesium oxide, magnesium hydroxide, and lithium nitrate in the above-described binder. The separator 130 may be a separator having no separator coating layer, or a separator having the separator coating layer.

An average thickness of the separator 130 including the separator coating layer is preferably 30 μm or less, more preferably 25 μm or less, and still more preferably 20 μm or less. In such a mode, the occupation volume of the separator 130 in the lithium secondary battery 100 decreases and therefore, the resulting lithium secondary battery 100 has a more improved energy density. In addition, the average thickness of the separator 130 is preferably 5.0 μm or more, more preferably 7.0 μm or more, and still more preferably 10 μm or more. In such a mode, the positive electrode 120 and the negative electrode 140 can be separated more reliably, and short circuiting of the battery can be further suppressed.

### (Positive Electrode)

The positive electrode 120 is not particularly limited insofar as it is a positive electrode commonly used in a lithium secondary battery, and a known material can be selected as needed, depending on the use of the lithium secondary battery. From the standpoint of improving the stability and output voltage of the battery, the positive electrode 120 preferably has a positive-electrode active material.

In a case where the positive electrode has a positive-electrode active material, typically, lithium ions are filled into and extracted from the positive-electrode active material by charging/discharging the battery.

The “positive-electrode active material” as used herein is a substance that causes an electrode reaction, that is, an oxidation reaction and a reduction reaction at the positive electrode. Specifically, examples of the positive-electrode active material include a host material for a lithium element (typically, lithium ions).

Such a positive-electrode active material is not particularly limited, and examples thereof include metal oxides and metal phosphates. The metal oxides are not particularly limited, and examples thereof include cobalt oxide-based compounds, manganese oxide-based compounds, and nickel oxide-based compounds. The metal phosphates are not particularly limited, and examples thereof include iron phosphate-based compounds and cobalt phosphate-based compounds. Examples of typical positive-electrode active materials include LiCoO₂, LiNiₓCo_{y}Mn_{z}O (x+y+z=1), LiNiₓCo_{y}Al_{z}O (x+y+z=1), LiNixMnyO (x+y=1), LiNiO₂, LiMn₂O₄, LiFePO, LiCoPO, LiFeOF, LiNiOF, and LiTiS₂. One or more of the positive-electrode active materials may be used alone or in combination.

The positive electrode 120 may contain components other than the aforesaid positive-electrode active material. Such a component is not particularly limited, and examples thereof include conductive aids, binders, and ionic conductive materials.

As the ionic conductive material in the positive electrode 120, the aforesaid material (for example, the aforesaid gel electrolyte or polymer electrolyte) may be used. The ionic conductive material in the positive electrode 120 may be a gel electrolyte. In such a mode, adhesion force between the positive electrode and the positive electrode current collector is improved by a function of the gel electrolyte, and it is possible to attach a thinner positive electrode current collector, and thus it is possible to further improve the energy density of the battery. In a case of attaching the positive electrode current collector to a surface of the positive electrode, a positive electrode current collector formed on a release paper may be used.

Examples of conductive aids that can be used in the positive electrode 120 include, but are not limited to, carbon black, single-wall carbon nanotubes (SWCNT), multi-wall carbon nanotubes (MWCNT), carbon nanofibers (CF), and acetylene black. The binder is not particularly limited, and examples thereof include polyvinylidene fluoride, polytetrafluoroethylene, styrene butadiene rubber, acrylic resins, and polyimide resins.

The content of the positive-electrode active material in the positive electrode 120 may be, for example, 50% by mass or more and 100% by mass or less based on the total amount of the positive electrode 120. The content of the conductive aid may be, for example, 0.50% by mass or more and 30% by mass or less based on the total amount of the positive electrode 120. The content of the binder may be, for example, 0.50% by mass or more and 30% by mass or less based on the total amount of the positive electrode 120. A content of the ionic conductive material may be, for example, 0.50% by mass or more and 30% by mass or less, and preferably 5.0% by mass or more and 20% by mass or less and more preferably 8.0% by mass or more and 15% by mass or less with respect to the entire positive electrode 120.

An average thickness of the positive electrode 120 is preferably 20 μm or more and 100 μm or less, more preferably 30 μm or more and 80 μm or less, and still more preferably 40 μm or more and 70 μm or less. However, the average thickness of the positive electrode can be appropriately adjusted according to a desired capacity of the battery.

### (Positive Electrode Current Collector)

The positive electrode current collector 110 is disposed on one side of the positive electrode 120. The positive electrode current collector is not particularly limited insofar as it is a conductor not reactive with a lithium ion in the battery. Examples of such a positive electrode current collector include aluminum. The positive electrode current collector 110 may not be provided, and in this case, the positive electrode itself acts as a current collector. The positive electrode current collector functions to transfer electrons to the positive electrode (in particular, the positive-electrode active material). The positive electrode current collector 110 is in physical and/or electrical contact with the positive electrode 120.

In the present embodiment, an average thickness of the positive electrode current collector is preferably 1.0 μm or more and 15 μm or less, more preferably 2.0 μm or more and 10 μm or less, and still more preferably 3.0 μm or more and 6.0 μm or less. In such a mode, the occupation volume of the positive electrode current collector in the lithium secondary battery 100 decreases and the resulting lithium secondary battery 100 therefore has a more improved energy density.

### (Use of Lithium Secondary Battery)

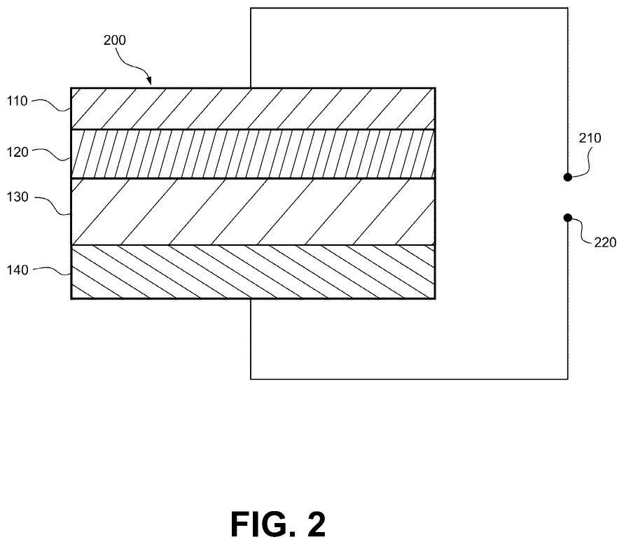

FIG. 2 shows one mode of the use of the lithium secondary battery according to the present embodiment. The lithium secondary battery 200 has a positive electrode terminal 210 and a negative electrode terminal 220 for connecting the lithium secondary battery 200 to an external circuit and these terminals are bonded to a positive electrode current collector 110 and the negative electrode 140, respectively. The lithium secondary battery 200 is charged and discharged by connecting the negative electrode terminal 220 to one end of the external circuit and the positive electrode terminal 210 to the other end of the external circuit. The external circuit is, for example, a resistor, a power source, a device, a device, another battery, a potentiostat, or the like.

More specifically, the lithium secondary battery 200 is charged by connecting an external power source to the positive electrode terminal 210 and the negative electrode terminal 220, and then applying a voltage between the positive electrode terminal 210 and the negative electrode terminal 220 to cause a current flow from the negative electrode terminal 220 (negative electrode 140) to the positive electrode terminal 210 (positive electrode 120) through the external circuit. In the lithium secondary battery 200, it is presumed that the solid electrolyte interfacial layer (SEI layer) is formed on the surface of the negative electrode 140 (at the interface between the negative electrode 140 and the separator 130) by initial charge, but the lithium secondary battery 200 may not have the SEI layer. By charging the lithium secondary battery 200, the lithium metal deposits on the interface between the negative electrode 140 and the SEI layer, on the interface between the negative electrode 140 and the separator 130, and/or on the interface between the SEI layer and the separator 130.

In addition, in a case where the negative electrode 140 of the lithium secondary battery 200 has a recessed portion or a through-hole, the SEI layer may be formed on an interface between the recessed portion or the through-hole of the negative electrode and the ionic conductive material by the initial charge. In a case where the lithium secondary battery having the recessed portion or the through-hole in the negative electrode 140 is charged, lithium metal may be deposited even on the surface of the recessed portion or the through-hole.

When the positive electrode terminal 210 and the negative electrode terminal 220 are connected to the desired charged lithium secondary battery 200 through the external circuit, the lithium secondary battery 200 is discharged. As a result, the deposition of the lithium metal generated on the negative electrode is electrolytically dissolved. When the SEI layer is formed in the lithium secondary battery 200, the lithium metal generated at least at the interface between the negative electrode and the SEI layer, the interface between the negative electrode and the separator, and/or the interface between the SEI layer and the separator is electrolytically dissolved.

In addition, in a case where the negative electrode of the lithium secondary battery 200 has a recessed portion or a through-hole, the lithium metal generated on the surface of the recessed portion or the through-hole may be electrolytically dissolved by the discharge.

### (Method of Manufacturing Lithium Secondary Battery)

A method of manufacturing the lithium secondary battery 100 as shown in FIG. 1 is not particularly limited insofar as it can provide a lithium secondary battery equipped with the aforesaid structure and examples of the method include the method as follows.

The positive electrode current collector 110 and the positive electrode 120 are produced, for example, in the following manner. The aforesaid positive-electrode active material and at least one of a conductive aid, an ionic conductive material, or a binder are mixed to obtain a positive electrode mixture. The mixing ratio thereof may be, for example, 50% by mass or more and 99% by mass or less of the positive-electrode active material, 0.5% by mass or more and 30% by mass or less of the conductive aid, 0.5% by mass or more and 30% by mass or less of the binder, and 0.5% by mass or more and 30% by mass or less of the ionic conductive material, based on the total amount of the aforesaid positive electrode mixture. The positive electrode mixture thus obtained is applied to one of the surfaces of a metal foil (for example, Al foil) serving as a positive electrode current collector and having a predetermined thickness (for example, 1.0 μm or more and 1.0 mm or less), followed by press molding. The molded product thus obtained is punched into a predetermined size to obtain a positive electrode current collector 110 and a positive electrode 120.

Next, as the negative electrode material, an Mg alloy or an Mg metal is prepared to have a thickness of, for example, 1.0 μm or more and 1.0 mm or less, washed with a solvent, punched out to have a predetermined size, and further washed with ethanol by ultrasonic washing, and then dried to obtain a negative electrode 140. In a case where the negative electrode having the recessed portion or the through-hole is used (see FIGS. 3 and 4), a plurality of recessed portions or through-holes may be formed by further processing (etching, mold casting, laser processing, punching, or the like) the negative electrode 140 obtained as described above.

In a case where the surface of the negative electrode material is coated with the aforesaid coating agent and then dried in the air as needed, a coating treatment may be performed.

Next, a separator 130 having the aforesaid structure is formed. As the separator 130, a separator produced by a conventionally known method or a commercially available one may be used.

In a case where an electrolyte solution is used as the ionic conductive material, the electrolyte solution may be prepared by using, as a solvent, the aforesaid solvent alone or a solution obtained by mixing two or more kinds of the aforesaid solvents, and then dissolving an electrolyte (for example, a lithium salt) in the solution. The mixing ratio of the solvent and the electrolyte may be appropriately adjusted such that the contents or concentrations of the solvent and the electrolyte are within the above-described ranges.

Thereafter, the positive electrode current collector 110 on which the positive electrode 120 is formed, the separator 130, and the negative electrode 140 obtained as described above are stacked in this order such that the positive electrode 120 faces the separator 130 to obtain a stacked body. The stacked body thus obtained is encapsulated, together with the electrolyte solution in a hermetically sealing container to obtain a lithium secondary battery 100.

In a case where a gel electrolyte or a polymer electrolyte is used as the ionic conductive material, the gel electrolyte or the polymer electrolyte may be prepared by a known production method or by purchasing a commercially available product. The gel electrolyte or the polymer electrolyte may be produced, for example, by mixing the aforesaid polymer, the aforesaid solvent, and/or the aforesaid electrolyte (for example, a lithium salt). The mixing ratio of the solvent and the electrolyte may be appropriately adjusted such that the contents or concentrations of the polymer, the solvent, and the electrolyte are within the above-described ranges.

Thereafter, in a lamination step of laminating the respective members in order, a gel-like ionic conductive material is applied between the respective members, or a solid ionic conductive material is adhered to the respective members to prepare the stacked body. The stacked body thus obtained is encapsulated in a hermetically sealing container to obtain a lithium secondary battery. The stacked body may be sealed in a hermetically sealing container together with the electrolyte solution.

The hermetically sealing container is not particularly limited, and examples thereof include a laminate film.

### Modified Examples

The aforesaid embodiments are examples for describing the present invention. They do not intend to limit the present invention only thereto and the present invention may have various modifications without departing from the gist thereof. In the lithium secondary battery 100, each member is a flat plate, but the shape of the lithium secondary battery according to the present embodiment is not particularly limited thereto. For example, each member may have a shape other than the flat plate shape, such as a cylindrical shape or a rectangular parallelepiped shape. In addition, in the lithium secondary battery 100, one of each member is included in one kind, but the lithium secondary battery according to the present embodiment may have a stacked structure including a plurality of various members.

For example, in the lithium secondary battery 100 according to the present embodiment, each configuration may be stacked (may be a plurality of layers) in the following order: positive electrode current collector/positive electrode/separator/negative electrode/separator/positive electrode/positive electrode current collector. In such a mode, the capacity of the lithium secondary battery can be improved further.

The lithium secondary battery according to the present embodiment may have, at the positive electrode current collector and/or negative electrode, a terminal for connecting it to an external circuit. For example, a metal terminal (for example, Al, Ni, or the like) having a length of 10 μm or more and 1.0 mm or less may be bonded to one or both of the positive electrode current collector and the negative electrode. For bonding, a conventionally known method may be used and for example, ultrasonic welding is usable.

The term “an energy density is high” or “has a high energy density” as used herein means that the capacity of a battery per total mass or total volume is high. It is preferably 800 Wh/L or more or 400 Wh/kg or more, and more preferably 900 Wh/L or more or 425 Wh/kg or more.

The term “having an excellent cycle characteristic” as used herein means that a decreasing ratio of the capacity of a battery is small before and after the expected number of charge/discharge cycles in ordinary use. In other words, when comparing a first discharge capacity after initial charging to a discharge capacity after the number of times of charge/discharge cycles that can be expected during normal use, the discharge capacity after the charge/discharge cycles has not declined significantly relative to the first discharge capacity after the initial charge.

### EXAMPLES

The present invention will hereinafter be described in detail by Examples and Comparative Examples. The present invention is not limited in any way by these examples.

### Example 1

A lithium secondary battery was produced as follows.

First, an Mg alloy foil (AZ31B) having a thickness of 30 μm was washed with a solvent containing sulfamic acid, and then washed with water. Subsequently, the Mg alloy foil was immersed in a solution containing 1H-benzotriazole as a negative electrode coating agent, dried, and further washed with water to obtain an Mg alloy foil coated with the negative electrode coating agent. The resulting Mg alloy foil was punched to a predetermined size (36.3 cm×36.3 cm) to obtain a negative electrode.

As a separator, a separator having a thickness of 16 μm and a predetermined size (38 cm×38 cm), in which both surfaces of a 12 μm-thick polyethylene microporous film were coated with a 2.0 μm-thick polyvinylidene fluoride (PVdF), was prepared.

Next, a mixture of 96 parts by mass LiNi_{0.85}Co_{0.12}Al_{0.03}O₂ positive-electrode active material, 2.0 parts by mass carbon black conductive aid, and 2.0 parts by mass polyvinylidene fluoride (PVdF) binder was applied to one surface of 12 μm-thick Al foil as a positive electrode current collector and press-molded. The resulting molded material was punched to a predetermined size (36.3 cm×36.3 cm) to obtain a positive electrode formed on the positive electrode current collector.

As an electrolyte solution, LiN(SO₂F)₂ (LIFSI) was dissolved in dimethoxyethane (DME) to prepare a 1.0 M LiFSI solution. A specific gravity of the prepared electrolyte solution was 1.45 g/cm³.

The positive electrode current collector, the positive electrode, the separator, and the negative electrode obtained as described above were stacked in this order to obtain a stacked body. Further, a 100-μm Al terminal and 100-μm Ni terminal were bonded to the positive electrode current collector and the negative electrode, respectively by ultrasonic welding and then the bonded body was inserted into a laminate-film outer container. Next, the electrolyte solution prepared as described above was injected into the outer container. The resulting outer container was hermetically sealed to obtain a lithium secondary battery.

### Examples 2 to 4

A lithium secondary battery was obtained in the same manner as in Example 1, except that an Mg alloy foil having a thickness shown in Table 3 was used as the negative electrode.

### Examples 5 to 8

A lithium secondary battery was obtained in the same manner as in Example 1, except that an Mg metal foil having a thickness shown in Table 3 was used as the negative electrode.

### Examples 9 to 12

A lithium secondary battery was obtained in the same manner as in Example 1, except that an Mg alloy foil (LZ91) having a thickness shown in Table 4 was used as the negative electrode.

### Example 13

Using an Mg alloy foil of LZ91 having a thickness of 20 μm, an Mg alloy foil (36.3 cm×36.3 cm) coated with the negative electrode coating agent was obtained in the same manner as in Example 1. Next, through-holes having a circular shape with an average pore diameter of 20 μm were formed on the Mg alloy foil by laser processing such that an opening ratio was 5.0%, thereby obtaining a negative electrode. A lithium secondary battery was obtained in the same manner as in Example 1, except that the negative electrode obtained as described above was used.

### Example 14

A lithium secondary battery was obtained in the same manner as in Example 13, except that, in the Mg alloy foil as the negative electrode, through-holes having an average pore diameter of 10 μm were formed such that an opening ratio was 10%.

### Example 15

In the same manner as in Example 13, a negative electrode, a positive electrode on which a positive electrode current collector had been formed, and a separator were prepared.

Next, a gel electrolyte was prepared as follows. Dimethoxyethane (DME) and 1,1,2,2-tetrafluoroethyl-2,2,3,3-tetrafluoropropyl ether (TTFE) were mixed so that a proportion thereof in terms of volume ratio was 2:8, and then LIN(SO₂F)₂ (LIFSI) was dissolved to a concentration of 1.2 M. A copolymer of vinylidene fluoride and hexafluoropropylene was mixed with the solution in an equal mass part (electrolyte solution:copolymer of vinylidene fluoride and hexafluoropropylene=1:1) to prepare a gel electrolyte. A specific gravity of the resulting gel electrolyte was 1.35 g/cc.

The positive electrode current collector, the positive electrode, the separator, and the negative electrode were stacked in this order to obtain a stacked body. In this case, the gel electrolyte was applied to the interface between the members. In this case, the through-holes formed in the negative electrode were filled with the gel electrolyte. A 100-μm Al terminal and 100-μm Ni terminal were bonded to the positive electrode current collector and the negative electrode, respectively by ultrasonic welding and then the bonded body was inserted into a laminate-film outer container. Next, the lithium secondary battery was obtained by sealing the outer container without injecting the electrolyte solution.

### Example 16

A lithium secondary battery was obtained in the same manner as in Example 15, except that, in the Mg alloy foil as the negative electrode, through-holes having a pore diameter of 10 μm were formed such that an opening ratio was 10%.

### Example 17

A lithium secondary battery was obtained in the same manner as in Example 15, except that, as the Mg alloy foil as the negative electrode, the Mg alloy foil having no through-hole, same one as in Example 10, was used.

### Comparative Example 1

A lithium secondary battery was produced as follows.

First, as a method for producing a negative electrode, a commercially available electrolytic Cu foil having a thickness of 8.0 μm was washed in the same manner as in Example 1, and a negative electrode coated with a negative electrode coating agent was prepared.

A positive electrode, a positive electrode current collector, a separator, and an electrolyte solution were prepared in the same manner as in Example 1.

The positive electrode current collector on which the positive electrode was formed, the separator, and the negative electrode obtained as described above were stacked in this order such that the positive electrode faced the separator to obtain a stacked body. Further, in the same manner as in Example 1, a 100-μm Al terminal and 100-μm Ni terminal were bonded to the positive electrode current collector and the negative electrode, respectively by ultrasonic welding and then the bonded body was inserted into a laminate-film outer container. Next, the electrolyte solution prepared as described above was injected into the outer container, and the outer container was sealed to obtain a lithium secondary battery.

### Comparative Examples 2 and 3

A lithium secondary battery was obtained in the same manner as in Comparative Example 1, except that an electrolytic Cu foil having a thickness shown in Table 5 was used as the negative electrode.

### [Evaluation of Energy Density]

The energy density of the lithium secondary batteries produced in Examples and Comparative Examples was evaluated. A product of the charge/discharge capacity and the average discharge voltage of the produced lithium secondary battery was divided by the total weight of the battery to obtain the energy density (Wh/kg). As the energy density is higher, the performance of the battery is more excellent.

TABLE 3

| | Example | Example | Example | Example | Example | Example | Example | Example |
|---|---|---|---|---|---|---|---|---|
| | 1 | 2 | 3 | 4 | 5 | 6 | 7 | 8 |
| Thickness of negative | 30 | 20 | 10 | 8 | 30 | 20 | 10 | 8 |
| electrode (μm) | | | | | | | | |
| Specific gravity of | 1.78 | 1.78 | 1.78 | 1.78 | 1.74 | 1.74 | 1.74 | 1.74 |
| negative electrode (g/cm³) | | | | | | | | |
| Mass of negative electrode | 7.03 | 4.68 | 2.34 | 1.87 | 6.86 | 4.57 | 2.29 | 1.83 |
| (g) | | | | | | | | |
| Electrolyte solution (g) | 7.50 | 7.50 | 7.50 | 7.50 | 7.50 | 7.50 | 7.50 | 7.50 |
| Total mass of battery (g) | 42.60 | 40.26 | 37.91 | 37.45 | 42.43 | 40.15 | 37.86 | 37.40 |
| Energy density (Wh/kg) | 446.02 | 471.97 | 501.12 | 507.39 | 447.76 | 473.27 | 501.86 | 507.99 |

TABLE 4

| | Example | Example | Example | Example | Example | Example | Example | Example | Example |
|---|---|---|---|---|---|---|---|---|---|
| | 9 | 10 | 11 | 12 | 13 | 14 | 15 | 16 | 17 |
| Thickness of negative | 30 | 20 | 10 | 8 | 20 | 20 | 20 | 20 | 20 |
| electrode (μm) | | | | | | | | | |
| Specific gravity of | 1.50 | 1.50 | 1.50 | 1.50 | 1.50 | 1.50 | 1.50 | 1.50 | 1.50 |
| negative electrode (g/cm³) | | | | | | | | | |
| Mass of negative electrode | 5.92 | 3.95 | 1.97 | 1.58 | 3.75 | 3.55 | 3.75 | 3.55 | 3.95 |
| (g) | | | | | | | | | |
| Electrolyte solution (g) | 7.50 | 7.50 | 7.50 | 7.50 | 7.50 | 7.50 | — | — | — |
| Gel electrolyte (g) | — | — | — | — | — | — | 6.72 | 6.72 | 6.72 |
| Total mass of battery (g) | 41.49 | 39.52 | 37.55 | 37.15 | 39.32 | 39.13 | 38.55 | 38.35 | 38.74 |
| Energy density (Wh/kg) | 457.90 | 480.77 | 506.04 | 511.42 | 483.18 | 485.62 | 492.91 | 495.44 | 490.40 |

TABLE 5

| | Comparative | Comparative | Comparative |
|---|---|---|---|
| | Example 1 | Example 2 | Example 3 |
| Thickness of negative | 8 | 10 | 20 |
| electrode (μm) | | | |
| Specific gravity of negative | 8.89 | 8.89 | 8.89 |
| electrode (g/cm³) | | | |
| Mass of negative electrode (g) | 9.36 | 11.70 | 23.39 |
| Electrolyte solution (g) | 7.50 | 7.50 | 7.50 |
| Total mass of battery (g) | 44.93 | 47.27 | 58.97 |
| Energy density (Wh/kg) | 422.87 | 401.95 | 322.21 |

From Tables 3 to 5, it was found that Examples 1 to 17 using the negative electrode consisting of the Mg alloy or the Mg metal had higher energy density as compared with Comparative Examples 1 to 3 not using the negative electrode consisting of the Mg alloy or the Mg metal.

It was found that Examples 13 to 16 in which the negative electrode having the through-holes on the surface thereof had higher energy density than the examples having the negative electrode of the same thickness. In addition, it was found that Examples 15 to 17 using the gel electrolyte instead of the electrolyte solution had higher energy density than the examples using the electrolyte solution.

The lithium secondary battery of the present invention has a high energy density so that it has industrial applicability as a power storage device to be used for various uses.

What is claimed is:

1. A lithium secondary battery that a lithium metal deposits on a surface of a negative electrode and charge/discharge are performed by electrolytically dissolving the deposited lithium metal,
wherein the negative electrode essentially consists of an Mg alloy or an Mg metal.

2. The lithium secondary battery according to claim 1,
wherein a plurality of recessed portions are formed on the surface of the negative electrode on which the lithium metal deposits.

3. The lithium secondary battery according to claim 2,
wherein the recessed portion is filled with a gel electrolyte.

4. The lithium secondary battery according to claim 1,
wherein a plurality of through-holes penetrating between the surface of the negative electrode on which the lithium metal deposits and a surface on a side opposite to the surface are formed in the negative electrode.

5. The lithium secondary battery according to claim 4,
wherein the through-hole is filled with a gel electrolyte.

6. The lithium secondary battery according to claim 1,
wherein an average thickness of the negative electrode is 3.0 μm or more and 30 μm or less.

7. The lithium secondary battery according to claim 1,
wherein a specific gravity of the negative electrode is 3.5 g/cm³ or less.

8. The lithium secondary battery according to claim 1,
wherein the Mg alloy contains 50 mol % or more of an Mg atom.

9. The lithium secondary battery according to claim 1,
wherein the Mg alloy is an alloy consisting of Mg and at least one selected from the group consisting of Al, Li, Zn, Mn, Fe, Si, Cu, Ni, and Ca.

10. The lithium secondary battery according to claim 1,
wherein, before an initial charge, a lithium foil is not formed on the surface of the negative electrode.

11. The lithium secondary battery according to claim 1,
wherein an energy density is 425 Wh/kg or more.
